(19) United States
(12) Patent Application Publication
(10) Pub. No.: US 2025/0206966 A1
(43) Pub. Date: Jun. 26, 2025

(54) ELECTRODEPOSITABLE COATING COMPOSITIONS

(71) Applicant: PPG INDUSTRIES OHIO, INC., Cleveland, OH (US)

(72) Inventors: David Alfred Stone, Allison Park, PA (US); Egle Puodziukynaite, Ridgecrest, CA (US); Marissa Elizabeth Johnson, Valencia, PA (US)

(73) Assignee: PPG INDUSTRIES OHIO, INC., Cleveland, OH (US)

(21) Appl. No.: 18/848,657

(22) PCT Filed: Mar. 20, 2023
(86) PCT No.: PCT/US2023/064699

§ 371 Date: Sep. 19, 2024

Related U.S. Application Data
(60) Provisional application No. 63/269,678, filed on Mar. 21, 2022.

(51) Int. Cl. C09D 5/44; B33Y 80/00; C09D 175/12

(52) U.S. Cl. CPC C09D 5/4473; C09D 5/4411; C09D 5/4465; C09D 175/12; B33Y 80/00

(57) ABSTRACT

The present disclosure is directed to an electrodepositable coating composition comprising: (a) a polyol comprising the residue of ethylene oxide and butylene oxide; (b) an ionic salt group containing film-forming polymer; and (c) a curing agent. Also disclosed are methods of coating substrates and coated substrates.

### FIELD

The present disclosure is directed toward an electrodepositable coating composition, methods of coating substrates, and treated substrates.

### BACKGROUND INFORMATION

Electrodeposition as a coating application method involves the deposition of a film-forming composition onto a conductive substrate under the influence of an applied electrical potential. Electrodeposition has gained popularity in the coatings industry because it provides higher paint utilization, outstanding corrosion resistance, and low environmental contamination as compared with non-electrophoretic coating methods. Both cationic and anionic electrodeposition processes are used commercially. Oil contamination on substrate surfaces is problematic for electrodepositable coating compositions. Oil deposits, such as oils used in automotive assembly lines, result in the formation of defects in the cured coating in the form of craters. These craters form when the electrodepositable coating composition de-wets from the area around where the oil was deposited, and the coating may cure around the oil deposit. The formation of craters affects both the smoothness and appearance of the cured coating and requires extra processing steps, such as sanding, to achieve the desired coating finish. An electrodepositable coating composition that provides resistance to oil contamination is desired.

### SUMMARY

The present disclosure provides an electrodepositable coating composition comprising: (a) a polyol comprising the residue of ethylene oxide and butylene oxide; (b) an ionic salt group containing film-forming polymer; and (c) a curing agent.

The present disclosure also provides a method of coating a substrate comprising electrophoretically applying one of the electrodepositable coating compositions described herein to at least a portion of the substrate and at least partially curing the coating composition to form a coating.

The present disclosure also provides a substrate coated with one of the electrodepositable coating compositions disclosed herein in an at least partially cured state.

The present disclosure also provides a substrate comprising a coating comprising (a) a polyol comprising the residue of ethylene oxide and butylene oxide; (b) an ionic group containing film-forming polymer; and (c) a curing agent.

### DETAILED DESCRIPTION

The present disclosure is directed to an electrodepositable coating composition comprising: (a) a polyol comprising the residue of ethylene oxide and butylene oxide; (b) an ionic salt group containing film-forming polymer; and (c) a curing agent.

According to the present disclosure, the term “electrodepositable coating composition” refers to a composition that is capable of being deposited onto an electrically conductive substrate under the influence of an applied electrical potential.

### Polyol

The electrodepositable coating compositions of the present disclosure may comprise a polyol comprising the residue of ethylene oxide and the residue of butylene oxide. As used herein, the term “polyol” means a compound comprising more than one hydroxyl group. The polyol of the present disclosure at least partially comprises constitutional units comprising the residue of ethylene oxide and constitutional units comprising the residue of butylene oxide. As used herein, the term “ethylene oxide” refers to an organic compound with the formula C₂H₄O and the structure:

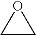

As used herein, the term “butylene oxide” refers to an organic compound with the formula C₄H₈O and the structure:

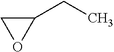

As used herein, the term “constitutional unit comprising the residue of” a monomer means a portion of the structure of the polyol that is attributable to the residue of an individual monomer following reaction of the monomer during polymerization to form a portion or structural unit of the polymer.

The polyol may comprise, consist essentially of, or consist of constitutional units comprising the residue of ethylene oxide and constitutional units comprising the residue of butylene oxide. The polyol may comprise a ratio of constitutional units comprising the residue of ethylene oxide to constitutional units comprising the residue of butylene oxide of at least 9:1, such as at least 4:1, such as at least 1:1, such as at least 2:1. The polyol may comprise a ratio of constitutional units comprising the residue of ethylene oxide to constitutional units comprising the residue of butylene oxide of no more than 1:9, such as no more than 1:7, such as no more than 1:5, such as no more than 1:4. The polyol may comprise a ratio of constitutional units comprising the residue of ethylene oxide to constitutional units comprising the residue of butylene oxide of 9:1 to 1:9, such as 4:1 to 1:9, such as 2:1 to 1:9, such as 1:1 to 1:9, such as 9:1 to 1:7, such as 4:1 to 1:7, such as 2:1 to 1:7, such as 1:1 to 1:7, such as 9:1 to 1:5, such as 4:1 to 1:5, such as 2:1 to 1:5, such as 1:1 to 1:5, such as 9:1 to 1:4, such as 4:1 to 1:4, such as 2:1 to 1:4, such as 1:1 to 1:4.

The polyol may be polymerized from a mixture of monomers comprising, consisting essentially of, or consisting of ethylene oxide and butylene oxide. The mixture of monomers may comprise a molar ratio of ethylene oxide to butylene oxide of at least 9:1, such as at least 4:1, such as at least 1:1, such as at least 2:1. The mixture of monomers may comprise a molar ratio of ethylene oxide to butylene oxide of no more than 1:9, such as no more than 1:7, such as no more than 1:5, such as no more than 1:4. The mixture of monomers may comprise a molar ratio of ethylene oxide to butylene oxide of 9:1 to 1:9, such as 4:1 to 1:9, such as 2:1 to 1:9, such as 1:1 to 1:9, such as 9:1 to 1:7, such as 4:1 to 1:7, such as 2:1 to 1:7, such as 1:1 to 1:7, such as 9:1 to 1:5, such as 4:1 to 1:5, such as 2:1 to 1:5, such as 1:1 to 1:5, such as 9:1 to 1:4, such as 4:1 to 1:4, such as 2:1 to 1:4, such as 1:1 to 1:4.

The polyol may comprise at least two hydroxyl groups, and may be difunctional, trifunctional, tetrafunctional, or have a higher functionality. As used herein, a “hydroxyl functional group” refers to an —OH group. As used herein, “difunctional,” when used with respect to the number of hydroxyl functional groups, means a particular monomer or polymer comprises, consists essentially of, or consists of two (2) hydroxyl functional groups per molecule. As used herein, “trifunctional,” when used with respect to the number of hydroxyl functional groups, means a monomer or polymer comprising, consisting essentially of, or consisting of three (3) hydroxyl functional groups per molecule. As used herein, “tetrafunctional,” when used with respect to the number of hydroxyl function groups, means a monomer or polymer comprising, consisting essentially of, or consisting of four (4) hydroxyl functional groups per molecule. For clarity, the polyol may comprise additional functional groups in addition to the hydroxyl functional groups.

The polyol may have a theoretical hydroxyl equivalent weight of at least 500 g/hydroxyl group (“OH”), such as at least 600 g/OH, such as at least 700 g/OH, such as at least 750 g/OH. The polyol may have a theoretical hydroxyl equivalent weight of no more than 2,000 g/OH, such as no more than 1,750 g/OH, such as no more than 1,500 g/OH, such as no more than 1,250 g/OH. The polyol may have a theoretical hydroxyl equivalent weight of 500 g/OH to 2,000 g/OH, such as 500 g/OH to 1,750 g/OH, such as 500 g/OH to 1,500 g/OH, such as 500 g/OH to 1,250 g/OH, such as 600 g/OH to 2,000 g/OH, such as 600 g/OH to 1,750 g/OH, such as 600 g/OH to 1,500 g/OH, such as 600 g/OH to 1,250 g/OH, such as 700 g/OH to 2,000 g/OH, such as 700 g/OH to 1,750 g/OH, such as 700 g/OH to 1,500 g/OH, such as 700 g/OH to 1,250 g/OH, such as 750 g/OH to 2,000 g/OH, such as 750 g/OH to 1,750 g/OH, such as 750 g/OH to 1,500 g/OH, such as 750 g/OH to 1,250 g/OH.

The polyol may have a hydroxyl value of at least 35 mg KOH/gram polyol, such as at least 40 mg KOH/gram polyol, such as at least 45 mg KOH/gram polyol, such as at least 50 mg KOH/gram polyol. The polyol may have a hydroxyl value of no more than 115 mg KOH/gram polyol, such as no more than 100 mg KOH/gram polyol, such as no more than 75 mg KOH/gram polyol, such as no more than 60 mg KOH/gram polyol. The polyol may have a hydroxyl value of 35 to 115 mg KOH/gram polyol, such as 35 to 100 mg KOH/gram polyol, such as 35 to 75 mg KOH/gram polyol, such as 35 to 60 mg KOH/gram polyol, such as 40 to 115 mg KOH/gram polyol, such as 40 to 100 mg KOH/gram polyol, such as 40 to 75 mg KOH/gram polyol, such as 40 to 60 mg KOH/gram polyol, such as 45 to 115 mg KOH/gram polyol, such as 45 to 100 mg KOH/gram polyol, such as 45 to 75 mg KOH/gram polyol, such as 45 to 60 mg KOH/gram polyol, such as 50 to 115 mg KOH/gram polyol, such as 50 to 100 mg KOH/gram polyol, such as 50 to 75 mg KOH/gram polyol, such as 50 to 60 mg KOH/gram polyol. As used herein, the term “hydroxyl value” typically refers to the number of milligrams of potassium hydroxide (KOH) required to neutralize the acetic acid taken up on acetylation of one gram of a chemical substance that contains free hydroxyl groups and was herein determined by a theoretical calculation of the number of free hydroxyl groups theoretically present in one gram of the polyol.

The polyol may have a theoretical molecular weight of at least 1,000 g, such as at least 1,250 g, such as at least 1,500 g. The polyol may have a theoretical molecular weight of no more than 3,000 g, such as no more than 2,750 g, such as no more than 2,500 g. The polyol may have a theoretical molecular weight of 1,000 g to 3,000 g, such as 1,000 g to 2,750 g, such as 1,000 g to 2,500 g, such as 1,250 g to 3,000 g, such as 1,250 g to 2,750 g, such as 1,250 g to 2,500 g, such as 1,500 g to 3,000 g, such as 1,500 g to 2,750 g, such as 1,500 g to 2,500 g. As used herein, the term “theoretical molecular weight” means the molecular weight that is calculated using the equation:

$$( 1 )$$

$$theoretical molecular weight = \frac{( 56 , 100 mg KOH / ( eq KOH ) ) ( total \# equivalents OH groups )}{( hydroxyl value )}$$

56,100 mg is the molecular weight of KOH. The “hydroxyl value” is the hydroxyl value as set forth above. The “total #equivalents OH groups” is the total number of equivalent hydroxyl groups present on one polyol molecule.

The polyol described above may be present in the electrodepositable coating composition in an amount of at least 0.5% by weight, such as at least 0.6% by weight, such as at least 0.8% by weight, such as at least 1% by weight, such as at least 5% by weight, based on the resin solids weight. The polyol described above may be present in the electrodepositable coating composition in an amount of no more than 15% by weight, such as no more than 12% by weight, such as no more than 10% by weight, such as no more than 8% by weight, based on the resin solids weight. The polyol described above may be present in the electrodepositable coating composition in an amount of 0.5% by weight to 15% by weight, such as 0.5% to 12% by weight, such as 0.5% to 10% by weight, such as 0.5% to 8% by weight, such as 0.6% to 15% by weight, such as 0.6% by weight to 12% by weight, such as 0.6% to 10% by weight, such as 0.6% to 8% by weight, such as 0.8% to 15% by weight, such as 0.8% to 12% by weight, such as 0.8% by weight to 10% by weight, such as 0.8% to 8% by weight, such as 1% to 15% by weight, such as 1% to 12% by weight, such as 1% by weight to 10% by weight, such as 1% by weight to 8% by weight, such as 5% to 15% by weight, such as 5% to 12% by weight, such as 5% to 10% by weight, such as 5% to 8% by weight, based on the resin solids weight.

### Ionic Salt Group-Containing Film-Forming Polymer

According to the present disclosure, the electrodepositable coating composition may further comprise an ionic salt group-containing film-forming polymer. The ionic salt group-containing film-forming polymer may be different from the polyol described above.

According to the present disclosure, the ionic salt group-containing film-forming polymer may comprise a cationic salt group-containing film-forming polymer. The cationic salt group-containing film-forming polymer may be used in a cationic electrodepositable coating composition. As used herein, the term “cationic salt group-containing film-forming polymer” refers to polymers that include at least partially neutralized cationic groups, such as sulfonium groups and ammonium groups, that impart a positive charge. As used herein, the term “polymer” encompasses, but is not limited to, oligomers and both homopolymers and copolymers. The cationic salt group-containing film-forming polymer may comprise active hydrogen functional groups. As used herein, the term “active hydrogen functional groups” refers to those groups that are reactive with isocyanates as determined by the Zerewitinoff test as is described in the Journal of the American Chemical Society, vol. 49, p. 3181 (1927), and include, for example, hydroxyl groups, primary or secondary amine groups, and thiol groups. Cationic salt group-containing film-forming polymers that comprise active hydrogen functional groups may be referred to as active hydrogen-containing, cationic salt group-containing film-forming polymers.

Examples of polymers that are suitable for use as the cationic salt group-containing film-forming polymer in the present disclosure include, but are not limited to, alkyd polymers, acrylics, polyepoxides, polyamides, polyurethanes, polyureas, polyethers, and polyesters, among others.

More specific examples of suitable active hydrogen-containing, cationic salt group-containing film-forming polymers include polyepoxide-amine adducts, such as polyglycidyl ethers of a polyphenol, such as Bisphenol A, and primary and/or secondary amines, such as are described in U.S. Pat. No. 4,031,050 at col. 3, In. 27 to col. 5, In. 50, U.S. Pat. No. 4,452,963 at col. 5, In. 58 to col. 6, In. 66, and U.S. Pat. No. 6,017,432 at col. 2, ln. 66 to col. 6, In. 26, these portions of which are incorporated herein by reference. A portion of the amine that is reacted with the polyepoxide may be a ketimine of a polyamine, as is described in U.S. Pat. No. 4,104,147 at col. 6, In. 23 to col. 7, In. 23, the cited portion of which being incorporated herein by reference. Also suitable are ungelled polyepoxide-polyoxyalkylenepolyamine resins, such as are described in U.S. Pat. No. 4,432,850 at col. 2, In. 60 to col. 5, In. 58, the cited portion of which being incorporated herein by reference. In addition, cationic acrylic resins, such as those described in U.S. Pat. No. 3,455,806 at col. 2, In. 18 to col. 3, In. 61 and U.S. Pat. No. 3,928,157 at col. 2, In. 29 to col. 3, In. 21, these portions of which being incorporated herein by reference, may be used.

Besides amine salt group-containing resins, quaternary ammonium salt group-containing resins may also be employed as a cationic salt group-containing film-forming polymer in the present disclosure. Examples of these resins are those which are formed from reacting an organic polyepoxide with a tertiary amine acid salt. Such resins are described in U.S. Pat. No. 3,962,165 at col. 2, In. 3 to col. 11, In. 7, U.S. Pat. No. 3,975,346 at col. 1, In. 62 to col. 17, In. 25, and U.S. Pat. No. 4,001,156 at col. 1, In. 37 to col. 16, In. 7, these portions of which being incorporated herein by reference. Examples of other suitable cationic resins include ternary sulfonium salt group-containing resins, such as those described in U.S. Pat. No. 3,793,278 at col. 1, In. 32 to col. 2, In. 20, this portion of which being incorporated herein by reference. Also, cationic resins which cure via a transesterification mechanism, such as described in European Pat. Application No. 12463B1 at pg. 2, In. 1 to pg. 6, In. 25, this portion of which being incorporated herein by reference, which also may be employed.

Other suitable cationic salt group-containing film-forming polymers include those that may form photodegradation resistant electrodepositable coating compositions. Such polymers include the polymers comprising cationic amine salt groups which are derived from pendant and/or terminal amino groups that are disclosed in U.S. Pat. Application Pub. No. 2003/0054193 A1 at pars. [0064] to [0088], this portion of which being incorporated herein by reference. Also suitable are the active hydrogen-containing, cationic salt group-containing resins derived from a polyglycidyl ether of a polyhydric phenol that is essentially free of aliphatic carbon atoms to which are bonded more than one aromatic group, which are described in U.S. Pat. Application Pub. No. 2003/0054193 A1 at pars. [0096] to [0123], this portion of which being incorporated hererin by reference.

The active hydrogen-containing, cationic salt group-containing film-forming polymer is made cationic and water dispersible by at least partial neutralization with an acid. Suitable acids include organic and inorganic acids. Non-limiting examples of suitable organic acids include formic acid, acetic acid, methanesulfonic acid, and lactic acid. Non-limiting examples of suitable inorganic acids include phosphoric acid and sulfamic acid. By “sulfamic acid” is meant sulfamic acid itself or derivatives thereof such as those having the formula:

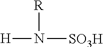

where R is hydrogen or an alkyl group having 1 to 4 carbon atoms. Mixtures of the above-mentioned acids also may be used in the present disclosure.

The extent of neutralization of the cationic salt group-containing film-forming polymer may vary with the particular polymer involved. However, sufficient acid should be used to sufficiently neutralize the cationic salt-group containing film-forming polymer such that the cationic salt group-containing film-forming polymer may be dispersed in an aqueous dispersing medium. For example, the amount of acid used may provide at least 20% of all of the total theoretical neutralization. Excess acid may also be used beyond the amount required for 100% total theoretical neutralization. For example, the amount of acid used to neutralize the cationic salt group-containing film-forming polymer may be <100% based on the total amines in the active hydrogen-containing, cationic salt group-containing film-forming polymer. The total amount of acid used to neutralize the cationic salt group-containing film-forming polymer may range between any combination of values, which were recited in the preceding sentences, inclusive of the recited values. For example, the total amount of acid used to neutralize the active hydrogen-containing, cationic salt group-containing film-forming polymer may be 20%, 35%, 50%, 60%, or 80% based on the total amines in the cationic salt group-containing film-forming polymer.

According to the present disclosure, the cationic salt group-containing film-forming polymer may be present in the cationic electrodepositable coating composition in an amount of at least 40% by weight, such as at least 50% by weight, such as at least 60% by weight, based on total weight of the resin solids of the electrodepositable coating composition. The cationic salt group-containing film-forming polymer may be present in the cationic electrodepositable coating composition in an amount of no more than 90% by weight, such as no more than 80% by weight, such as no more than 75% by weight, based on total weight of the resin solids of the electrodepositable coating composition. The cationic salt group-containing film-forming polymer may be present in the cationic electrodepositable coating composition in an amount of 40% to 90% by weight, such as 40% to 80% by weight, such as 40% to 75% by weight, such as 50% to 90% by weight, such as 50% to 80% by weight, such as 50% to 75% by weight, such as 60% to 90% by weight, such as 60% to 80% by weight, such as 60% to 75% by weight, based on total weight of the resin solids of the electrodepositable coating composition.

As used herein, the term “resin solids” includes the ionic salt group-containing film-forming polymer, the curing agent, the polyol, and any additional water-dispersible non-pigmented component(s) present in the electrodepositable coating composition.

According to the present disclosure, the ionic salt group-containing film-forming polymer may comprise an anionic salt group-containing film-forming polymer. As used herein, the term “anionic salt group-containing film-forming polymer” refers to an anionic polymer comprising at least partially neutralized anionic functional groups, such as carboxylic acid and phosphoric acid groups that impart a negative charge. The anionic salt group-containing film-forming polymer may comprise active hydrogen functional groups. Anionic salt group-containing film-forming polymers that comprise active hydrogen functional groups may be referred to as active hydrogen-containing, anionic salt group-containing film-forming polymers. The anionic salt group-containing film-forming polymer may be used in an anionic electrodepositable coating composition.

The anionic salt group-containing film-forming polymer may comprise base-solubilized, carboxylic acid group-containing film-forming polymers such as the reaction product or adduct of a drying oil or semi-drying fatty acid ester with a dicarboxylic acid or anhydride; and the reaction product of a fatty acid ester, unsaturated acid or anhydride and any additional unsaturated modifying materials which are further reacted with the polyol. Also suitable are the at least partially neutralized interpolymers of hydroxyl-alkyl esters of unsaturated carboxylic acids, unsaturated carboxylic acids, and at least one other ethylenically unsaturated monomer. Still another suitable anionic electrodepositable resin comprises an alkyd-aminoplast vehicle, i.e., a vehicle containing an alkyd resin and an amine-aldehyde resin. Another suitable anionic electrodepositable resin composition comprises mixed esters of a resinous polyol. Other acid functional polymers may also be used such as phosphatized polyepoxide or phosphatized acrylic polymers. Exemplary phosphatized polyepoxides are disclosed in U.S. Pat. Application Publication No. 2009/0045071 at pars. [0004] to [0015] and U.S. patent application Ser. No. 13/232,093 at pars. [0014] to [0040], the cited portions of which being incorporated herein by reference. Also suitable are resins comprising one or more pendant carbamate functional groups, such as those described in U.S. Pat. No. 6,165,338.

According to the present disclosure, the anionic salt group-containing film-forming polymer may be present in the anionic electrodepositable coating composition in an amount of at least 50% by weight, such as at least 55% by weight, such as at least 60% by weight, based on total weight of the resin solids of the electrodepositable coating composition. The anionic salt group-containing film-forming polymer may be present in the anionic electrodepositable coating composition in an amount of no more than 90% by weight, such as no more than 80% by weight, such as no more than 75% by weight, based on total weight of the resin solids of the electrodepositable coating composition. The anionic salt group-containing film-forming polymer may be present in the anionic electrodepositable coating composition in an amount of 50% to 90% by weight, such as 50% to 80% by weight, such as 50% to 75% by weight, such as 55% to 90% by weight, such as 55% to 80% by weight, such as 55% to 75% by weight, such as 60% to 90% by weight, such as 60% to 80% by weight, such as 60% to 75% by weight, based on total weight of the resin solids of the electrodepositable coating composition.

According to the present disclosure, the ionic salt group-containing film-forming polymer may be present in the electrodepositable coating composition in an amount of at least 39.5% by weight, such as at least 50% by weight, such as at least 55% by weight, such as at least 60% by weight, based on total weight of the resin solids of the electrodepositable coating composition. The ionic salt group-containing film-forming polymer may be present in the electrodepositable coating composition in an amount of no more than 90% by weight, such as no more than 80% by weight, such as no more than 75% by weight, based on total weight of the resin solids of the electrodepositable coating composition. The ionic salt group-containing film-forming polymer may be present in the electrodepositable coating composition in an amount of 39.5% to 90% by weight, such as 39.5% to 80% by weight, such as 39.5% to 75% by weight, such as 50% to 90% by weight, such as 50% to 80% by weight, such as 50% to 75% by weight, such as 55% to 90% by weight, such as 55% to 80% by weight, such as 55% to 75% by weight, such as 60% to 90% by weight, such as 60% to 80% by weight, such as 60% to 75% by weight, based on total weight of the resin solids of the electrodepositable coating composition.

### Curing Agent

According to the present disclosure, the electrodepositable coating composition of the present disclosure may further comprise a curing agent. The curing agent may be reactive with the polyol and the ionic salt group-containing film-forming polymer. The curing agent may react with the reactive groups, such as active hydrogen groups, of the ionic salt group-containing film-forming polymer and the reactive groups of the polyol to effectuate cure of the coating composition to form a coating. As used herein, the terms “cure,” “cured,” or similar terms, as used in connection with the electrodepositable coating compositions described herein, means that at least a portion of the components that form the electrodepositable coating composition are crosslinked to form a coating. Additionally, curing of the electrodepositable coating composition refers to subjecting said composition to curing conditions (e.g., elevated temperature) leading to the reaction of the reactive functional groups of the components of the electrodepositable coating composition, and resulting in the crosslinking of the components of the composition and formation of an at least partially cured coating. Non-limiting examples of suitable curing agents are at least partially blocked polyisocyanates, aminoplast resins, and phenoplast resins, such as phenolformaldehyde condensates, including allyl ether derivates thereof.

Suitable at least partially blocked polyisocyanates include aliphatic polyisocyanates, aromatic polyisocyanates, and mixtures thereof. The curing agent may comprise an at least partially blocked aliphatic polyisocyanate. Suitable at least partially blocked aliphatic polyisocyanates include, for example, fully blocked aliphatic polyisocyanates, such as those described in U.S. Pat. No. 3,984,299 at col. 1, In. 57 to col. 3, In. 15, the portion of which is incorporated herein by reference, or partially blocked aliphatic polyisocyanates that are reacted with the ionic salt group-containing film-forming polymer backbone, such as is described in U.S. Pat. No. 3,947,338 at col. 2, In. 65 to col. 4, In. 30, the portion of which is also incorporated herein by reference. By “blocked” is meant that the isocyanate groups have been reacted with a compound such that the resultant blocked isocyanate group is stable to active hydrogens at ambient temperature but reactive with active hydrogens in the film-forming polymer at elevated temperatures, such as between 90° C. and 200° C. The polyisocyanate curing agent may be a fully blocked polyisocyanate substantially free of isocyanate groups.

The polyisocyanate curing agent may comprise a diisocyanate, higher functional polyisocyanates, or combinations thereof. For example, the polyisocyanate curing agent may comprise aliphatic and/or aromatic polyisocyanates. Aliphatic polyisocyanates may include (i) alkylene isocyanates, such as trimethylene diisocyanate, tetramethylene diisocyanate, pentamethylene diisocyanate, hexamethylene diisocyanate (“HDI”), 1,2-propylene diisocyanate, 1,2-butylene diisocyanate, 2,3-butylene diisocyanate, 1,3-butylene diisocyanate, ethylidene diisocyanate, and butylidene diisocyanate, and (ii) cycloalkylene isocyanates, such as 1,3-cyclopentane diisocyanate, 1,4-cyclohexane diisocyanate, 1,2-cyclohexane diisocyanate, isophorone diisocyanate, methylene bis(4-cyclohexylisocyanate) (“HMDI”), the cyclo-trimer of 1,6-hexmethylene diisocyanate (also known as the isocyanurate trimer of HDI), commercially available as Desmodur N3300 from Covestro AG), and meta-tetramethylxylylene diisocyanate (commercially available as TMXDI® from Allnex SA). Aromatic polyisocyanates may include (i) arylene isocyanates, such as m-phenylene diisocyanate, p-phenylene diisocyanate, 1,5-naphthalene diisocyanate and 1,4-naphthalene diisocyanate, and (ii) alkarylene isocyanates, such as 4,4′-diphenylene methane (“MDI”), 2,4-tolylene or 2,6-tolylene diisocyanate (“TDI”), or mixtures thereof, 4,4-toluidine diisocyanate and xylylene diisocyanate. Triisocyanates, such as triphenyl methane-4,4′4″-triisocyanate, 1,3,5-triisocyanato benzene and 2,4,6-triisocyanato toluene, tetraisocyanates, such as 4,4′-diphenyldimethyl methane-2,2′,5,5′-tetraisocyanate, and polymerized polyisocyanates, such as tolylene diisocyanate dimers and trimers and the like, may also be used. The curing agent may comprise a blocked polyisocyanate selected from a polymeric polyisocyanate, such as polymeric HDI, polymeric MDI, polymeric isophorone diisocyanate, and the like. The curing agent may also comprise a blocked trimer of hexamethylene diisocyanate available as Desmodur N3300® from Covestro AG. Mixtures of polyisocyanate curing agents may also be used.

The polyisocyanate curing agent may be at least partially blocked by the polyol described above. Alternatively or in addition to the polyol, the polyisocyanate curing agent may be at least partially blocked with at least one blocking agent selected from a 1,2-alkane diol, for example 1,2-propanediol; a 1,3-alkane diol, for example 1,3-butanediol; a benzylic alcohol, for example, benzyl alcohol; an allylic alcohol, for example, allyl alcohol; caprolactam; a dialkylamine, for example, dibutylamine; and mixtures thereof. The polyisocyanate curing agent may be at least partially blocked with at least one 1,2-alkane diol having three or more carbon atoms, for example 1,2-butanediol.

Other suitable blocking agents include aliphatic, cycloaliphatic, or aromatic alkyl monoalcohols or phenolic compounds, including, for example, lower aliphatic alcohols, such as methanol, ethanol, and n-butanol; cycloaliphatic alcohols, such as cyclohexanol; aromatic-alkyl alcohols, such as phenyl carbinol and methylphenyl carbinol; and phenolic compounds, such as phenol itself and substituted phenols wherein the substituents do not affect coating operations, such as cresol and nitrophenol. Glycol ethers and glycol amines may also be used as blocking agents. Suitable glycol ethers include ethylene glycol butyl ether, diethylene glycol butyl ether, ethylene glycol methyl ether, and propylene glycol methyl ether. Other suitable blocking agents include oximes, such as methyl ethyl ketoxime, acetone oxime, and cyclohexanone oxime.

The curing agent may comprise an aminoplast resin. Aminoplast resins are condensation products of an aldehyde with an amino- or amido-group carrying substance. Condensation products obtained from the reaction of alcohols and an aldehyde with melamine, urea, or benzoguanamine may be used. However, condensation products of other amines and amides may also be employed, for example, aldehyde condensates of triazines, diazines, triazoles, guanidines, guanamines, and alkyl- and aryl-substituted derivatives of such compounds, including alkyl- and aryl-substituted ureas and alkyl- and aryl-substituted melamines. Some examples of such compounds are N,N′-dimethyl urea, benzourea, dicyandiamide, formaguanamine, acetoguanamine, ammeline, 2-chloro-4,6-diamino-1,3,5-triazine, 6-methyl-2,4-diamino-1,3,5-triazine, 3,5-diaminotriazole, triaminopyrimidine, 2-mercapto-4,6-diaminopyrimidine, 3,4,6-tris(ethylamino)-1,3,5-triazine, and the like. Suitable aldehydes include formaldehyde, acetaldehyde, crotonaldehyde, acrolein, benzaldehyde, furfural, glyoxal, and the like.

The aminoplast resins may contain methylol or similar alkylol groups, and at least a portion of these alkylol groups may be etherified by a reaction with an alcohol to provide organic solvent-soluble resins. Any monohydric alcohol may be employed for this purpose, including such alcohols as methanol, ethanol, propanol, butanol, pentanol, hexanol, heptanol, and others, as well as benzyl alcohol, and other aromatic alcohols, cyclic alcohol such as cyclohexanol, monoethers of glycols such as Cello solves and Carbitols, and halogen-substituted or other substituted alcohols, such as 3-chloropropanol and butoxyethanol.

Non-limiting examples of commercially available aminoplast resins are those available under the trademark CYMEL® from Allnex Belgium SA/NV, such as CYMEL 1130 and 1156, and RESIMENE® from INEOS Melamines, such as RESIMENE 750 and 753. Examples of suitable aminoplast resins also include those described in U.S. Pat. No. 3,937,679 at col. 16, In. 3 to col. 17, In. 47, the portion of which being hereby incorporated by reference. As is disclosed in the aforementioned portion of the '679 patent, the aminoplast may be used in combination with the methylol phenol ethers.

Phenoplast resins are formed by the condensation of an aldehyde and a phenol. Suitable aldehydes include formaldehyde and acetaldehyde. Methylene-releasing and aldehyde-releasing agents, such as paraformaldehyde and hexamethylene tetramine, may also be utilized as an aldehyde agent. Various phenols may be used, such as phenol itself, a cresol, or a substituted phenol in which a hydrocarbon radical having either a straight chain, a branched chain, or a cyclic structure is substituted for a hydrogen in the aromatic ring. Mixtures of phenols may also be employed. Some specific examples of suitable phenols are p-phenylphenol, p-tert-butylphenol, p-tert-amylphenol, cyclopentylphenol, and unsaturated hydrocarbon-substituted phenols, such as the monobutenyl phenols containing a butenyl group in ortho, meta, or para position, and where the double bond occurs in various positions in the hydrocarbon chain.

Aminoplast and phenoplast resins, as described above, are described in U.S. Pat. No. 4,812,215 at col. 6, In. 20 to col. 7, In. 12, the cited portion of which incorporated herein by reference.

The curing agent may be present in the cationic electrodepositable coating composition in an amount of at least 10% by weight, such as at least 20% by weight, such as at least 25% by weight, based on total weight of the resin solids of the electrodepositable coating composition. The curing agent may be present in the cationic electrodepositable coating composition in an amount of no more than 60% by weight, such as no more than 50% by weight, such as no more than 40% by weight, based on total weight of the resin solids of the electrodepositable coating composition. The curing agent may be present in the cationic electrodepositable coating composition in an amount of 10% to 60% by weight, such as 10% to 50% by weight, such as 10% to 40% by weight, such as 20% to 60% by weight, such as 20% to 50% by weight, such as 20% to 40% by weight, such as 25% to 60% by weight, such as 25% to 50% by weight, such as 25% to 40% by weight, based on total weight of the resin solids of the electrodepositable coating composition.

The curing agent may be present in the anionic electrodepositable coating composition in an amount of at least 10% by weight, such as at least 20% by weight, such as at least 25% by weight, based on the total weight of the resin solids of the electrodepositable coating composition. The curing agent may be present in the anionic electrodepositable coating composition in an amount of no more than 50% by weight, such as no more than 45% by weight, such as no more than 40% by weight, based on the total weight of the resin solids of the electrodepositable coating composition. The curing agent may be present in the anionic electrodepositable coating composition in an amount of 10% to 50% by weight, such as 10% to 45% by weight, such as 10% to 40% by weight, such as 20% to 50% by weight, such as 20% to 45% by weight, such as 20% to 40% by weight, such as 25% to 50% by weight, such as 25% to 45% by weight, such as 25% to 40% by weight, based on the total weight of the resin solids of the electrodepositable coating composition.

The curing agent may be present in the electrodepositable coating composition in an amount of at least 10% by weight, such as at least 20% by weight, such as at least 25% by weight, based on the total weight of the resin solids of the electrodepositable coating composition. The curing agent may be present in the electrodepositable coating composition in an amount of no more than 60% by weight, such as no more than 50% by weight, such as no more than 45% by weight, such as no more than 40% by weight, based on the total weight of the resin solids of the electrodepositable coating composition. The curing agent may be present in the electrodepositable coating composition in an amount of 10% to 60% by weight, such as 10% to 50% by weight, such as 10% to 45% by weight, such as 10% to 40% by weight, such as 20% to 60% by weight, such as 20% to 50% by weight, such as 20% to 45% by weight, such as 20% to 40% by weight, such as 25% to 60% by weight, such as 25% to 50% by weight, such as 25% to 45% by weight, such as 25% to 40% by weight, based on the total weight of the resin solids of the electrodepositable coating composition.

### Further Components of the Electrodepositable Coating Compositions

The electrodepositable coating composition according to the present disclosure may optionally comprise one or more further components in addition to the polyol, the ionic salt group-containing film-forming polymer, and the curing agent described above.

The electrodepositable coating composition may further comprise a polyetheramine-adduct comprising an ungelled ionic reaction product prepared from reactants comprising: (a) a reaction product prepared from reactants comprising: (1) a polyol different from the polyol discussed above; and (2) an epoxy functional material; and (b) a polyetheramine.

Examples of suitable polyols useful for forming the ungelled ionic reaction product include resorcinol, dihydroxy benzene, aliphatic, cycloaliphatic, or aralaphatic hydroxyl containing compounds, such as ethylene glycol, propylene glycol, Bisphenol A, dihydroxyl cyclohexane, dimethylol cyclohexane, or combinations thereof. The polyol may be present in the polyetheramine adduct in an amount of, for example, 0% to 20% by weight based on the total weight of the reactants that form the polyester reaction product, such as 0% to 15% by weight.

Examples of suitable epoxy-functional materials useful for forming the ungelled ionic reaction product contain at least one epoxy group in the molecule, such as di- or polyglycidyl ethers of polyhydric alcohols, such as a polyglycidyl ether of Bisphenol A. Suitable epoxy-functional materials may have an epoxy equivalent weight ranging from, for example, 90 to 2,000 g/equivalent of epoxide functional group, as measured by titration with perchloric acid using methyl violet as an indicator. The epoxy-functional material may comprise, for example, 10% to 40% by weight based on the total weight of the epoxy-functional polyester, such as 15% to 35% by weight of the epoxy-functional material if combined or reacted with the polyether described above to form the epoxy functional polyester.

According to the present disclosure, the polyetheramine adduct may be formed by reacting the ungelled ionic reaction product with at least one polyetheramine such as one characterized by propylene oxide, ethylene oxide, or mixed propylene oxide and ethylene oxide repeating units in their respective structures, such as, for example, one of the Jeffamine series products (commercially available from Huntsman Corporation). Examples of such polyetheramines include animated propoxylated pentaerythritols, such as Jeffamine XTJ-616, and those represented by Formulas (I) through (III).

According to Formula (I) of the present disclosure the polyetheramine may comprise or represent:

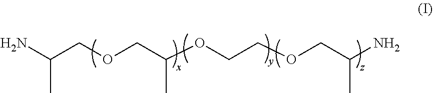

wherein y=0-39, x+z=1-68.

Suitable polyetheramines represented by Formula (I) include, but are not limited to, amine-terminated polyethylene glycol such as Huntsman Corporation Jeffamine ED series, such as Jeffamine HK-511, Jeffamine ED-600, Jeffamine ED-900, and Jeffamine ED-2003, and amine-terminated polypropylene glycol such as Huntsman Corporation Jeffamine D series, such as Jeffamine D-230, Jeffamine D-400, Jeffamine D-2000, and Jeffamine D-4000.

According to Formula (II) of the present disclosure the polyetheramine may comprise or represent:

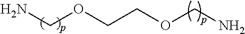

wherein each p independently is 2 or 3.

Suitable polyetheramines represented by Formula (II) include, but are not limited to, amine-terminated polyethylene glycol based diamine, such as Huntsman Corporation Jeffamine EDR series, such as Jeffamine EDR-148 and Jeffamine EDR-176.

According to Formula (III) of the present disclosure, the polyetheramine may comprise or represent:

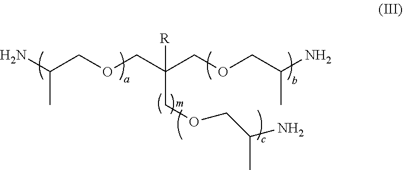

wherein R is H or C₂H₅, m-0 or 1, and a+b+c=5-85.

Suitable polyetheramines represented by Formula (III) include, but are not limited to, amine-terminated propoxylated trimethylolpropane or glycerol, such as Huntsman Corporation Jeffamine T series, such as Jeffamine T-403, Jeffamine T-3000, and Jeffamine T-5000.

Further examples of the polyetheramine-adduct are those described in U.S. Pat. Nos. 4,420,574 and 4,423,166, which are incorporated herein by reference.

According to the present disclosure, the polyetheramine-adduct may be present in the electrodepositable coating composition in an amount of at least 3% by weight based on total weight of the resin solids, such as at least 5% by weight, such as at least 10% by weight, such as at least 15% by weight, and no more than 20% by weight, such as no more than 15% by weight, such as no more than 10% by weight, such as no more than 5% by weight based on total weight of the resin solids. The polyetheramine may be present in the electrodepositable coating composition in an amount of 3% to 20% by weight based on total weight of the resin solids, such as 5% to 15% by weight, such as 5% to 10% by weight.

According to the present disclosure, the electrodepositable coating composition may optionally comprise a catalyst to catalyze the reaction between the curing agent, the polyol, and the ionic salt group-containing film-forming polymer. Examples of catalysts suitable for cationic electrodepositable coating compositions include, without limitation, organotin compounds (e.g., dibutylin oxide and dioctyltin oxide) and salts thereof (e.g., dibutylin diacetate); other metal oxides (e.g., oxides of cerium, zirconium, and bismuth) and salts thereof (e.g., bismuth sulfamate and bismuth lactate); or a cyclic guanidine as described in U.S. Pat. No. 7,842,762 at col. 1, In. 53 to col. 4, In. 18 and col. 16, In. 62 to col. 19, In. 8, the cited portions of which incorporated herein by reference. Examples of catalysts suitable for anionic electrodepositable coating compositions include latent acid catalysts, specific examples of which are identified in WO 2007/118024 at par. [0031] and include, but are not limited to, ammonium hexafluoroantimonate, quaternary salts of SbF₆ (e.g., NACURE® XC-7231), t-amine salts of SbF₆ (e.g., NACURE® XC-9223), Zn salts of triflic acid (e.g., NACURE® A202 and A218), quaternary salts of triflic acid (e.g., NACURE® XC-A230), and diethylamine salts of triflic acid (e.g., NACURE® A233), all commercially available from King Industries, and/or mixtures thereof. Latent acid catalysts may be formed by preparing a derivative of an acid catalyst such as para-toluenesulfonic acid (pTSA) or other sulfonic acids. For example, a well-known group of blocked acid catalysts are amine salts of aromatic sulfonic acids, such as pyridinium para-toluenesulfonate. Such sulfonate salts are less active than the free acid in promoting crosslinking. During cure, the catalysts may be activated by heating.

According to the present disclosure, the electrodepositable coating compositions of the present disclosure may optionally comprise crater control additives which may be incorporated into the coating composition.

According to the present disclosure, the electrodepositable coating composition may optionally comprise a silicone additive. The silicone additive may comprise a polyether modified silicone compound, a polyester modified silicone compound, a polyacrylic modified silicone compound, or any combination thereof. Non-limiting examples of the polyether modified silicone compound include compounds in which a polyether chain is introduced into terminal and/or side chains of a polysiloxane polymer. For example, the polyether modified silicone compound may be a compound in which a polyether chain is introduced into side chains of polysiloxane polymer such as polydimethylsiloxane. Non-limiting examples of the polyester modified silicone compound include compounds in which a polyester chain is introduced into terminal and/or side chains of a polysiloxane polymer. For example, the polyester modified silicone compound may be a compound in which a polyester chain is introduced into side chains of a polysiloxane polymer such as polydimethylsiloxane. Non-limiting examples of the polyacrylic modified silicone compound include compounds in which a polyacrylic chain is introduced into terminal and/or side chains of a polysiloxane polymer. For example, the polyacrylic modified silicone compound may be a compound in which a polyacrylic chain is introduced into side chains of a polysiloxane polymer such as polydimethylsiloxane. Non-limiting examples of suitable commercially available silicone additives include those sold under the trade name TEGO® Wet, commercially available from Evonik Operations GmbH, such as TEGO® Wet 260, TEGO® Wet 265, TEGO® Wet 270, and TEGO® Wet 280.

The electrodepositable coating composition may optionally further comprise a pigment. The pigment may comprise any suitable pigment. Non-limiting examples of pigment include iron oxides, lead oxides, strontium chromate, carbon black, coal dust, titanium dioxide, barium sulfate, a color pigment, a phyllosilicate pigment, a metal pigment, a thermally conductive, electrically insulative filler, fire-retardant pigment, as well as color pigments such as cadmium yellow, cadmium red, chromium yellow, and the like, or any combination thereof.

The pigment-to-binder (P:B) ratio as set forth in this disclosure may refer to the weight ratio of the pigment-to-binder in the electrodepositable coating composition, and/or the weight ratio of the pigment-to-binder in the deposited wet film, and/or the weight ratio of the pigment to the binder in the dry, uncured deposited film, and/or the weight ratio of the pigment-to-binder in the cured film. The pigment-to-binder (P:B) ratio of the pigment to the electrodepositable binder may be at least 0.05:1, such as at least 0.1:1, such as at least 0.2:1, such as at least 0.30:1, such as at least 0.35:1, such as at least 0.40:1, such as at least 0.50:1, such as at least 0.60:1, such as at least 0.75:1, such as at least 1:1, such as at least 1.25:1, such as at least 1.5:1. The pigment-to-binder (P:B) ratio of the pigment to the electrodepositable binder may be no more than 2.0:1, such as no more than 1.75:1, such no more than 1.5:1, such as no more than 1.25:1, such as no more than 1:1, such as no more than 0.75:1, such as no more than 0.70:1, such as no more than 0.60:1, such as no more than 0.55:1, such as no more than 0.50:1, such as no more than 0.30:1, such as no more than 0.20:1, such as no more than 0.10:1. The pigment-to-binder (P:B) ratio of the pigment to the electrodepositable binder may be 0.05:1 to 2.0:1, such as 0.05:1 to 1.75:1, such as 0.05:1 to 1.50:1, such as 0.05:1 to 1.25:1, such as 0.05:1 to 1:1, such as 0.05:1 to 0.75:1, such as 0.05:1 to 0.70:1, such as 0.05:1 to 0.60:1, such as 0.05:1 to 0.55:1, such as 0.05:1 to 0.50:1, such as 0.05:1 to 0.30:1, such as 0.05:1 to 0.20:1, such as 0.05:1 to 0.10:1, such as 0.1:1 to 2.0:1, such as 0.1:1 to 1.75:1, such as 0.1:1 to 1.50:1, such as 0.1:1 to 1.25:1, such as 0.1:1 to 1:1, such as 0.1:1 to 0.75:1, such as 0.1:1 to 0.70:1, such as 0.1:1 to 0.60:1, such as 0.1:1 to 0.55:1, such as 0.1:1 to 0.50:1, such as 0.1:1 to 0.30:1, such as 0.1:1 to 0.20:1, such as 0.2:1 to 2.0:1, such as 0.2:1 to 1.75:1, such as 0.2:1 to 1.50:1, such as 0.2:1 to 1.25:1, such as 0.2:1 to 1:1, such as 0.2:1 to 0.75:1, such as 0.2:1 to 0.70:1, such as 0.2:1 to 0.60:1, such as 0.2:1 to 0.55:1, such as 0.2:1 to 0.50:1, such as 0.2:1 to 0.30:1, such as 0.3:1 to 2.0:1, such as 0.3:1 to 1.75:1, such as 0.3:1 to 1.50:1, such as 0.3:1 to 1.25:1, such as 0.3:1 to 1:1, such as 0.3:1 to 0.75:1, such as 0.3:1 to 0.70:1, such as 0.3:1 to 0.60:1, such as 0.3:1 to 0.55:1, such as 0.3:1 to 0.50:1, such as 0.3:1 to 0.30:1, such as 0.35:1 to 2.0:1, such as 0.35:1 to 1.75:1, such as 0.35:1 to 1.50:1, such as 0.35:1 to 1.25:1, such as 0.35:1 to 1:1, such as 0.35:1 to 0.75:1, such as 0.35:1 to 0.70:1, such as 0.35:1 to 0.60:1, such as 0.35:1 to 0.55:1, such as 0.35:1 to 0.50:1, such as 0.4:1 to 2.0:1, such as 0.4:1 to 1.75:1, such as 0.4:1 to 1.50:1, such as 0.4:1 to 1.25:1, such as 0.4:1 to 1:1, such as 0.4:1 to 0.75:1, such as 0.4:1 to 0.70:1, such as 0.4:1 to 0.60:1, such as 0.4:1 to 0.55:1, such as 0.4:1 to 0.50:1, such as 0.5:1 to 2.0:1, such as 0.5:1 to 1.75:1, such as 0.5:1 to 1.50:1, such as 0.5:1 to 1.25:1, such as 0.5:1 to 1:1, such as 0.5:1 to 0.75:1, such as 0.5:1 to 0.70:1, such as 0.5:1 to 0.60:1, such as 0.5:1 to 0.55:1, such as 0.6:1 to 2.0:1, such as 0.6:1 to 1.75:1, such as 0.6:1 to 1.50:1, such as 0.6:1 to 1.25:1, such as 0.6:1 to 1:1, such as 0.6:1 to 0.75:1, such as 0.6:1 to 0.70:1, such as 0.75:1 to 2.0:1, such as 0.75:1 to 1.75:1, such as 0.75:1 to 1.50:1, such as 0.75:1 to 1.25:1, such as 0.75:1 to 1:1, such as 1:1 to 2.0:1, such as 1:1 to 1.75:1, such as 1:1 to 1.50:1, such as 1:1 to 1.25:1, such as 1.25:1 to 2.0:1, such as 1.25:1 to 1.75:1, such as 1.25:1 to 1.50:1, such as 1.50:1 to 2.0:1, such as 1.50:1 to 1.75:1.

According to the present disclosure, the electrodepositable coating composition may comprise other optional ingredients, if desired, including various additives such as fillers, plasticizers, antioxidants, biocides, UV light absorbers and stabilizers, hindered amine light stabilizers, defoamers, fungicides, dispersing aids, flow control agents, surfactants, wetting agents, or combinations thereof. Alternatively, the electrodepositable coating composition may be completely free of any of the optional ingredients, i.e., the optional ingredient is not present in the electrodepositable coating composition. The other additives mentioned above may be present in the electrodepositable coating composition in amounts of 0.01% to 3% by weight, based on total weight of the resin solids of the electrodepositable coating composition.

According to the present disclosure, the electrodepositable coating composition may comprise water and/or one or more organic solvent(s). Water can for example be present in amounts of 40% to 90% by weight, such as 50% to 75% by weight, based on total weight of the electrodepositable coating composition. Examples of suitable organic solvents include oxygenated organic solvents, such as monoalkyl ethers of ethylene glycol, diethylene glycol, propylene glycol, and dipropylene glycol which contain from 1 to 10 carbon atoms in the alkyl group, such as the monoethyl and monobutyl ethers of these glycols. Examples of other at least partially water-miscible solvents include alcohols such as ethanol, isopropanol, butanol, and diacetone alcohol. If used, the organic solvents may typically be present in an amount of less than 10% by weight, such as less than 5% by weight, based on total weight of the electrodepositable coating composition. The electrodepositable coating composition may in particular be provided in the form of a dispersion, such as an aqueous dispersion.

According to the present disclosure, the total solids content of the electrodepositable coating composition may be at least 1% by weight, such as at least 5% by weight, and may be no more than 50% by weight, such as no more than 40% by weight, such as no more than 20% by weight, based on the total weight of the electrodepositable coating composition. The total solids content of the electrodepositable coating composition may be from 1% to 50% by weight, such as 5% to 40% by weight, such as 5% to 20% by weight, based on the total weight of the electrodepositable coating composition. As used herein, “total solids” refers to the non-volatile content of the electrodepositable coating composition, i.e., materials which will not volatilize when heated to 110° C. for 15 minutes.

The electrodepositable coating composition may be substantially free, essentially free, or completely free of catalytic tin. As used herein, the electrodepositable coating composition is “substantially free” of catalytic tin if catalytic tin is present in an amount of less than 0.1% by weight, based on the total weight of the electrodepositable coating composition. As used herein, the electrodepositable coating composition is “essentially free” of catalytic tin if catalytic tin is present in an amount of less than 0.01%, based on the total weight of the electrodepositable coating composition. As used herein, the electrodepositable coating composition is “completely free” of catalytic tin if catalytic tin is present in an amount of 0.001%, based on the total weight of the electrodepositable coating composition.

### Substrates

According to the present disclosure, the electrodepositable coating composition may be electrophoretically applied to a substrate. The cationic electrodepositable coating composition may be electrophoretically deposited upon any electrically conductive substrate. Suitable substrates include metal substrates, metal alloy substrates, and/or substrates that have been metallized, such as nickel-plated plastic. Additionally, substrates may comprise non-metal conductive materials including composite materials such as, for example, materials comprising carbon fibers or conductive carbon. According to the present disclosure, the metal or metal alloy may comprise cold rolled steel, hot rolled steel, steel coated with zinc metal, zinc compounds, or zinc alloys, such as electrogalvanized steel, hot-dipped galvanized steel, galvanealed steel, and steel plated with zinc alloy. Aluminum alloys of the 2XXX, 5XXX, 6XXX, or 7XXX series as well as clad aluminum alloys and cast aluminum alloys of the A356 series also may be used as the substrate. Magnesium alloys of the AZ31B, AZ91C, AM60B, or EV31A series also may be used as the substrate. The substrate used in the present disclosure may also comprise titanium and/or titanium alloys. Other suitable non-ferrous metals include copper and magnesium, as well as alloys of these materials. Suitable metal substrates for use in the present disclosure include those that are often used in the assembly of vehicular bodies (e.g., without limitation, door, body panel, trunk deck lid, roof panel, hood, roof and/or stringers, rivets, landing gear components, and/or skins used on an aircraft), a vehicular frame, vehicular parts, motorcycles, wheels, industrial structures and components such as appliances, including washers, dryers, refrigerators, stoves, dishwashers, and the like, agricultural equipment, lawn and garden equipment, air conditioning units, heat pump units, lawn furniture, and other articles. As used herein, “vehicle” or variations thereof includes, but is not limited to, civilian, commercial and military aircraft, and/or land vehicles such as cars, motorcycles, and/or trucks. The metal substrate also may be in the form of, for example, a sheet of metal, or a fabricated part. It will also be understood that the substrate may be pretreated with a pretreatment solution including a zinc phosphate pretreatment solution such as, for example, those described in U.S. Pat. Nos. 4,793,867 and 5,588,989, or a zirconium containing pretreatment solution such as, for example, those described in U.S. Pat. Nos. 7,749,368 and 8,673,091.

In examples, the substrate may comprise a three-dimensional component formed by an additive manufacturing process such as selective laser melting, e-beam melting, directed energy deposition, binder jetting, metal extrusion, and the like. In examples, the three-dimensional component may be a metal and/or resinous component.

### Methods of Coating, Coatings, and Coated Substrates

The present disclosure is also directed to methods for coating a substrate, such as any one of the electroconductive substrates mentioned above. According to the present disclosure, such method may comprise electrophoretically applying an electrodepositable coating composition as described above to at least a portion of the substrate and curing the coating composition to form an at least partially cured coating on the substrate. According to the present disclosure, the method may comprise (a) electrophoretically depositing onto at least a portion of the substrate an electrodepositable coating composition of the present disclosure and (b) heating the coated substrate to a temperature and for a time sufficient to cure the electrodeposited coating on the substrate. According to the present disclosure, the method may optionally further comprise (c) applying directly to the at least partially cured electrodeposited coating one or more pigment-containing coating compositions and/or one or more pigment-free coating compositions to form a top coat over at least a portion of the at least partially cured electrodeposited coating, and (d) heating the coated substrate of step (c) to a temperature and for a time sufficient to cure the top coat.

According to the present disclosure, the cationic electrodepositable coating composition of the present disclosure may be deposited upon an electrically conductive substrate by placing the composition in contact with an electrically conductive cathode and an electrically conductive anode, with the surface to be coated being the cathode. Following contact with the composition, an adherent film of the coating composition is deposited on the cathode when a sufficient voltage is impressed between the electrodes. The conditions under which the electrodeposition is carried out are, in general, similar to those used in electrodeposition of other types of coatings. The applied voltage may be varied and can be, for example, as low as one volt to as high as several thousand volts, such as between 50 and 500 volts. The current density may be between 0.5 ampere and 15 amperes per square foot and tends to decrease during electrodeposition, indicating the formation of an insulating film.

Once the cationic electrodepositable coating composition is electrodeposited over at least a portion of the electroconductive substrate, the coated substrate is heated to a temperature and for a time sufficient to at least partially cure the electrodeposited coating on the substrate. As used herein, the term “at least partially cured” with respect to a coating refers to a coating formed by subjecting the coating composition to curing conditions such that a chemical reaction of at least a portion of the reactive groups of the components of the coating composition occurs to form a coating. The coated substrate may be heated to a temperature ranging from 250° F. to 450° F. (121.1° C. to 232.2° C.), such as from 275° F. to 400° F. (135° C. to 204.4° C.), such as from 300° F. to 360° F. (149° C. to 180° C.). The curing time may be dependent upon the curing temperature as well as other variables, for example, the film thickness of the electrodeposited coating, level, and type of catalyst present in the composition and the like. For purposes of the present disclosure, all that is necessary is that the time be sufficient to effect cure of the coating on the substrate. For example, the curing time can range from 10 minutes to 60 minutes, such as 20 to 40 minutes. The thickness of the resultant cured electrodeposited coating may range from 15 to 50 microns.

According to the present disclosure, the anionic electrodepositable coating composition of the present disclosure may be deposited upon an electrically conductive substrate by placing the composition in contact with an electrically conductive cathode and an electrically conductive anode, with the surface to be coated being the anode. Following contact with the composition, an adherent film of the coating composition is deposited on the anode when a sufficient voltage is impressed between the electrodes. The conditions under which the electrodeposition is carried out are, in general, similar to those used in electrodeposition of other types of coatings. The applied voltage may be varied and can be, for example, as low as one volt to as high as several thousand volts, such as between 50 and 500 volts. The current density may be between 0.5 ampere and 15 amperes per square foot and tends to decrease during electrodeposition indicating the formation of an insulating film.

Once the anionic electrodepositable coating composition is electrodeposited over at least a portion of the electroconductive substrate, the coated substrate may be heated to a temperature and for a time sufficient to at least partially cure the electrodeposited coating on the substrate. As used herein, the term “at least partially cured” with respect to a coating refers to a coating formed by subjecting the coating composition to curing conditions such that a chemical reaction of at least a portion of the reactive groups of the components of the coating composition occurs to form a coating. The coated substrate may be heated to a temperature ranging from 200° F. to 450° F. (93° C. to 232.2° C.), such as from 275° F. to 400° F. (135° C. to 204.4° C.), such as from 300° F. to 360° F. (149° C. to 180° C.). The curing time may be dependent upon the curing temperature as well as other variables, for example, film thickness of the electrodeposited coating, level, and type of catalyst present in the composition and the like. For purposes of the present disclosure, all that is necessary is that the time be sufficient to effect cure of the coating on the substrate. For example, the curing time may range from 10 to 60 minutes, such as 20 to 40 minutes. The thickness of the resultant cured electrodeposited coating may range from 15 to 50 microns.

The electrodepositable coating compositions of the present disclosure may also, if desired, be applied to a substrate using non-electrophoretic coating application techniques, such as flow, dip, spray and roll coating applications. For non-electrophoretic coating applications, the coating compositions may be applied to conductive substrates as well as non-conductive substrates such as glass, wood, and plastic.

The present disclosure is further directed to a coating formed by at least partially curing the electrodepositable coating composition described herein.

The present disclosure is further directed to a substrate that is coated, at least in part, with the electrodepositable coating composition described herein. The coating optionally may be in an at least partially or fully cured state. The coated substrate may comprise a coating comprising a polyol comprising the residue of ethylene oxide and butylene oxide; an ionic salt group-containing film-forming polymer different from the polyol; and a curing agent.

### Multi-Layer Coating Composites

The electrodepositable coating compositions of the present disclosure may be utilized in an electrocoating layer that is part of a multi-layer coating composite comprising a substrate with various coating layers. The coating layers may include a pretreatment layer, such as a phosphate layer (e.g., zinc phosphate layer), an electrocoating layer which results from the aqueous resinous dispersion of the present disclosure, and suitable top coat layers (e.g., base coat, clear coat layer, pigmented monocoat, and color-plus-clear composite compositions). It is understood that suitable topcoat layers include any of those known in the art, and each independently may be waterborne, solventborne, in solid particulate form (i.e., a powder coating composition), or in the form of a powder slurry. The top coat typically includes a film-forming polymer, crosslinking material and, if a colored base coat or monocoat, one or more pigments. According to the present disclosure, the primer layer is disposed between the electrocoating layer and the base coat layer. According to the present disclosure, one or more of the topcoat layers are applied onto a substantially uncured underlying layer. For example, a clear coat layer may be applied onto at least a portion of a substantially uncured basecoat layer (wet-on-wet), and both layers may be simultaneously cured in a downstream process.

Moreover, the top coat layers may be applied directly onto the electrodepositable coating layer. In other words, the substrate lacks a primer layer. For example, a basecoat layer may be applied directly onto at least a portion of the electrodepositable coating layer.

It will also be understood that the top coat layers may be applied onto an underlying layer despite the fact that the underlying layer has not been fully cured. For example, a clearcoat layer may be applied onto a basecoat layer even though the basecoat layer has not been subjected to a curing step. Both layers may then be cured during a subsequent curing step thereby eliminating the need to cure the basecoat layer and the clearcoat layer separately.

According to the present disclosure, additional ingredients such as colorants and fillers may be present in the various coating compositions from which the top coat layers result. Any suitable colorants and fillers may be used. For example, the colorant may be added to the coating in any suitable form, such as discrete particles, dispersions, solutions, and/or flakes. A single colorant or a mixture of two or more colorants can be used in the coatings of the present disclosure. It should be noted that, in general, the colorant can be present in a layer of the multi-layer composite in any amount sufficient to impart the desired property, visual, and/or color effect.

Example colorants include pigments, dyes, and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant may be organic or inorganic and may be agglomerated or non-agglomerated. Colorants may be incorporated into the coatings by grinding or simple mixing. Colorants may be incorporated by grinding into the coating by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthroapyrimidine, flavanthrone, pyranthrone, anthanthrone, dioxazine, triarylcarbonium, quinophthalone pigments, diketo pyrrolo pyrrole red (“DPP red BO”), titanium dioxide, carbon black, zinc oxide, antimony oxide, etc. and organic or inorganic UV opacifying pigments such as iron oxide, transparent red or yellow iron oxide, phthalocyanine blue, and mixtures thereof. The terms “pigment” and “colored filler” can be used interchangeably.

Example dyes include, but are not limited to, those that are solvent and/or aqueous based such as acid dyes, azoic dyes, basic dyes, direct dyes, disperse dyes, reactive dyes, solvent dyes, sulfur dyes, mordant dyes, for example, bismuth vanadate, anthraquinone, perylene, aluminum, quinacridone, thiazole, thiazine, azo, indigoid, nitro, nitroso, oxazine, phthalocyanine, quinoline, stilbene, and triphenyl methane.

Example tints include, but are not limited to, pigments dispersed in water-based or water miscible carriers such as AQUA-CHEM 896, commercially available from Degussa, Inc., CHARISMA COLORANTS and MAXITONER INDUSTRIAL COLORANTS, commercially available from Accurate Dispersions Division of Eastman Chemical, Inc.

The colorant may be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions may include colorants such as pigments or dyes having a particle size of less than 150 nm, such as less than 70 nm, such as less than 30 nm. Nanoparticles may be produced by milling stock organic or inorganic pigments with grinding media having a particle size of less than 0.5 mm. Example nanoparticle dispersions and methods for making them are identified in U.S. Pat. No. 6,875,800 B2, incorporated herein by reference. Nanoparticle dispersions may also be produced by crystallization, precipitation, gas phase condensation, and chemical attrition (i.e., partial dissolution). In order to minimize re-agglomeration of nanoparticles within the coating, a dispersion of resin-coated nanoparticles may be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in U.S. patent application Ser. No. 10/876,031, filed Jun. 24, 2004, incorporated herein by reference, and U.S. Provisional Pat. Application No. 60/482,167, filed Jun. 24, 2003, also incorporated herein by reference.

According to the present disclosure, special effect compositions that may be used in one or more layers of the multi-layer coating composite include pigments and/or compositions that produce one or more appearance effects such as reflectance, pearlescence, metallic sheen, phosphorescence, fluorescence, photochromism, photosensitivity, thermochromism, goniochromism, and/or color-change. Additional special effect compositions may provide other perceptible properties, such as reflectivity, opacity, or texture. For example, special effect compositions may produce a color shift, such that the color of the coating changes when the coating is viewed at different angles. Example color effect compositions are identified in U.S. Pat. No. 6,894,086, incorporated herein by reference. Additional color effect compositions may include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

According to the present disclosure, a photosensitive composition and/or photochromic composition, which reversibly alters its color when exposed to one or more light sources, can be used in a number of layers in the multi-layer composite. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. For example, the photochromic and/or photosensitive composition may be colorless in a non-excited state and exhibit a color in an excited state. Full color-change may appear within milliseconds to several minutes, such as from 20 seconds to 60 seconds. Example photochromic and/or photosensitive compositions include photochromic dyes.

According to the present disclosure, the photosensitive composition and/or photochromic composition may be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with the present disclosure, have minimal migration out of the coating. Example photosensitive compositions and/or photochromic compositions and methods for making them are identified in U.S. patent application Ser. No. 10/892,919, filed Jul. 16, 2004, incorporated herein by reference.

For purposes of this detailed description, it is to be understood that the disclosure may assume alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, “including,” “containing,” and like terms are understood in the context of this application to be synonymous with “comprising” and are therefore open-ended and do not exclude the presence of additional undescribed or unrecited elements, materials, ingredients, or method steps. As used herein, “consisting of” is understood in the context of this application to exclude the presence of any unspecified element, ingredient, or method step. As used herein, “consisting essentially of” is understood in the context of this application to include the specified elements, materials, ingredients, or method steps “and those that do not materially affect the basic and novel characteristic(s)” of what is being described.

In this application, the use of the singular includes the plural and plural encompasses the singular, unless specifically stated otherwise. For example, although reference is made herein to “an” ionic salt group-containing film-forming polymer, “a” curing agent, or “a” polyol, a combination (i.e., a plurality) of these components may be used. In addition, in this application, the use of “or” means “and/or” unless specifically stated otherwise, even though “and/or” may be explicitly used in certain instances.

Whereas specific aspects of the disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure which is to be given the full breadth of the claims appended and any and all equivalents thereof.

Illustrating the disclosure are the following examples, which, however, are not to be considered as limiting the disclosure to their details. Unless otherwise indicated, all parts and percentages in the following examples, as well as throughout the specification, are by weight.

### EXAMPLES

### Example 1: Preparation of a Blocked Polyisocyanate Curing Agent

A blocked polyisocyanate curing agent comprising isocyanato groups blocked with an alcohol mixture was prepared as follows: Components 2-6 listed in Table 1, below, were mixed in a flask set up for total reflux with stirring under nitrogen. The mixture was heated to a temperature of 30° C., and Component 1 was added dropwise so that the temperature increased due to the reaction exotherm and was maintained under 100° C. After the addition of Component 1 was complete, a temperature of 100° C. was established in the reaction mixture and the reaction mixture held at temperature until no residual isocyanate was detected by IR spectroscopy. Component 7 was then added, and the reaction mixture was allowed to stir for 30 minutes at 100° C. before cooling to ambient temperature.

TABLE 1

| No. | Component | Parts by Weight |
|---|---|---|
| 1 | Polymeric methylene diphenyl di-isocyanate¹ | 1206.0 |
| 2 | Dibutyltin dilaurate | 1.0 |
| 3 | Methyl isobutyl ketone | 159.6 |
| 4 | 2-Butoxyethanol | 106.2 |
| 5 | 2-(2-Butoxyethoxy)ethanol | 510.3 |
| 6 | Methanol | 158.4 |
| 7 | Methyl isobutyl ketone | 122.4 |

¹Rubinate M, available from Huntsman Corporation.

### Examples 2 to 5: Preparation of a Cationic, Amine-Functionalized, Polyepoxide-Based Resin

Each of Examples 2 to 5 were prepared as follows: A cationic, amine-functionalized, polyepoxide-based polymeric resin was prepared in the following manner. Components 1-6 listed in Table 2, below, were mixed in a flask set up for total reflux with stirring under nitrogen. The mixture was heated to a temperature of 130° C. and allowed to exotherm (175° C. maximum). A temperature of 145° C. was established in the reaction mixture and the reaction mixture was then held at that temperature for 2 hours. Components 7-9 were introduced slowly while allowing the mixture to cool to 125° C. followed by the addition of Component 10. A temperature of 105° C. was established, and Components 11 and 12 were then added to the reaction mixture quickly (sequential addition) and the reaction mixture was allowed to exotherm. A temperature of 120° C. was established and the reaction mixture held for 1 hour.

A portion of the Resin Synthesis Product (Component 13) was then poured into a pre-mixed solution of Components 14 and 15 to form a resin dispersion, and the resin dispersion was stirred for 1 hour. Component 16 was then introduced over 30 minutes to further dilute the resin dispersion, followed by the addition of Component 17. The MIBK in the resin dispersion was removed from the dispersion under vacuum at a temperature of 60-70° C.

The solids content of the resulting resin dispersion was determined by adding a quantity of the resin dispersion to a tared aluminum dish, recording the initial weight of the resin dispersion, heating the resin dispersion in the dish for 60 minutes at 110° C. in an oven, allowing the dish to cool to ambient temperature, reweighing the dish to determine the amount of non-volatile content remaining, and calculating the solids content by dividing the weight of the remaining non-volatile content by the initial resin dispersion weight and multiplying by 100. The solids contents of Resin Dispersions 2-5 are reported in Table 2.

TABLE 2

| | | Example: | | | |
|---|---|---|---|---|---|
| | | 2 | 3 | 4 | 5 |
| No. | Material | Resin Synthesis Stage - Parts by Weight | | | |
| 1 | Bisphenol A | 614.7 | 614.7 | 614.7 | 614.7 |
| | diglycidyl ether¹ | | | | |
| 2 | Bisphenol A | 180.8 | 180.8 | 180.8 | 180.8 |
| 3 | Cyclohexylamine | 41.9 | 41.9 | 41.9 | 41.9 |
| 4 | Bisphenol A - | 139.0 | 139.0 | 124.0 | — |
| | ethylene oxide | | | | |
| | adduct | | | | |
| | (1/6 molar | | | | |
| | ratio BPA/EO) | | | | |
| 5 | Methyl isobutyl ketone | 30.2 | 30.2 | 29.7 | 29.7 |
| | (MIBK) | | | | |
| 6 | Ethyl triphenyl | 0.3 | 0.3 | 0.3 | 0.3 |
| | phosphonium | | | | |
| | bromide | | | | |
| 7 | Methyl isobutyl ketone | 102.1 | 91.7 | 108.0 | 60.6 |
| 8 | EO-BO Polyol² | — | 31.4 | 47.2 | 194.8 |
| 9 | Bisphenol A - | 26.0 | 26.0 | 26.0 | — |
| | ethylene oxide | | | | |
| | adduct | | | | |
| | (1/6 molar | | | | |
| | ratio BPA/EO) | | | | |
| 10 | Example 1 | 547.0 | 547.0 | 549.9 | 549.5 |
| 11 | Diethylene | 48.6 | 48.6 | 48.6 | 48.6 |
| | triamine - MIBK | | | | |
| | dikctiminc ³ | | | | |
| 12 | Methyl Ethanol Amine | 44.4 | 44.4 | 44.4 | 44.4 |

Resin Dispersion Stage

| | | | | | |
|---|---|---|---|---|---|
| 13 | Resin Synthesis Product | 1774.9 | 1616.3 | 1633.5 | 1588.6 |
| 14 | Formic Acid | 22.0 | 22.0 | 22.1 | 22.1 |
| | (90% in water) | | | | |
| 15 | DI Water | 935.0 | 967.4 | 955.1 | 996.2 |
| 16 | DI Water | 1142.7 | 1165.7 | 1168.0 | 1166.3 |
| 17 | DI Water | 1000.0 | 1000.0 | 1000.0 | 1000.0 |

Dispersions Solids (wt %)

| | | | |
|---|---|---|---|
| 39.11 | 38.72 | 38.37 | 37.79 |

¹EPON 828, available from Hexion Corporation.
²Newpol EB-2000 available from SANAM Corporation. A polyol consisting of ethylene oxide: butylene oxide units in a 30%:70% ratio with a molecular weight of 2,000 ± 500.
³ 72.7% by weight (in MIBK) of the diketimine reaction product of 1 equivalent of diethylene triamine and 2 equivalents of MIBK.

### Example 6: Preparation of a Polyetheramine Adduct

TABLE 3

| | | Parts-by-weight |
|---|---|---|
| No. | Component | (grams) |
| 1 | DER 732¹ | 642.0 |
| 2 | Bisphenol A diglycidyl ether² | 376.0 |
| 3 | Bisphenol A | 342.0 |
| 4 | N,N-benzyldimethlamine | 1.50 |
| 5 | Butylcarbtiol Fomal³ | 178.84 |
| 6 | Methoxypropanol | 53.6 |
| 7 | Diethanol amine | 31.56 |
| 8 | N-methylethanol amine | 2.45 |
| 9 | Jeffamine D400⁴ | 218.00 |
| 10 | Acetic Acid | 40.61 |
| 11 | DI Water | 1695.15 |
| 12 | Di Water | 682.23 |

¹Aliphatic epoxy resin available from Dow Chemical Co.
²EPON 828, available from Hexion Corporation.
³Available as MAZON 1651 from BASF Corporation.
⁴Polyoxypropylene diamine available from Huntsman Corp.

A polyetheramine adduct was prepared from the components listed in Table 3 according to the following procedure: Components 1, 2, and 3 are charged into a suitably equipped round-bottomed flask. The mixture is heated to 130° C. and Material 4 is added. The reaction mixture is held at 150° C. until the epoxide equivalent weight of the mixture is 1361. Material 5 and 6 is then added and the mixture is cooled to 98° C. Material 7-8 is added and the reaction held at 95° C. for 30 minutes. Charge 9 is then added and help at 100° C. until the Gardner-Holdt viscosity of a sample of the resin diluted 50/50 in methoxy propanol is unchanged for 30 minutes. The resin is poured into a mixture of charges 10 and 11 and mixed for 30 minutes. Charge 12 is then added and mixed for at least 1 hour. The final aqueous dispersion had a measured solids content of 42.0%.

### Example 7: Synthesis of a Cationic Salt Group-Containing Polymeric Dispersant

TABLE 4

| Charge # | Material | Amount (g) |
|---|---|---|
| 1 | Dowanol ™ PnB | 65.0 |
| | Dowano ™ PM | 83.5 |
| | Butyl Cellosolve | 198.5 |
| | Deionized Water | 13.9 |
| 2 | Ethyl Acrylate | 353.4 |
| | Styrene | 62.1 |
| | 2-Hydroxypropyl Methacrylate | 93.0 |
| | Methyl Methacrylate | 260.4 |
| | Glycidyl Methacrylate | 139.5 |
| | Allyl Methacrylate | 11.5 |
| | t-Dodecyl Mercaptan | 9.3 |
| 3 | Vazo ™ 67¹ | 18.5 |
| | Dowanol ™ PnB | 29.5 |
| | Dowanol ™ PM | 14.8 |
| | Methyl Isobutyl Kctonc | 11.8 |
| 4 | Lupersol 7M50 | 18.6 |
| | Dowanol ™ PnB | 14.8 |
| | Dowanol ™ PM | 7.4 |
| 5 | Butyl Cellosolve | 80.3 |
| 6 | Diethanol amine | 99.6 |
| 7 | Deionized Water | 3334.0 |
| | Formic Acid (90% in water) | 34.2 |
| 8 | Deionized water | 1151.5 |

¹2,2′-azobis(2-methylbutyronitrile) free radical initiator available from The Chemours Company.

A cationic salt group-containing polymeric dispersant was prepared from the components listed in Table 4 according to the following procedure: Charge 1 was added to a 4-necked flask fitted with a thermocouple, nitrogen sparge, and a mechanical stirrer. Under a nitrogen blanket and agitation, the flask was heated to reflux with a temperature set point of 100° C. Charges 2 and 3 were added dropwise from an addition funnel over 150 minutes followed by a 30-minute hold. After increasing the temperature to 120° C., charge 4 was subsequently added over 15 minutes followed by a 10-minute hold. The temperature was decreased to 110° C. while adding charge 5 to help cool the reaction. Charge 6 was added and the temperature was held at 115° C. for 3 hours. During the hold, charge 7 was heated to approximately 35-40° C. in a separate container outfitted with a mechanical stirrer. After the hold, the contents from the reactor were poured into the container that includes charge 7 under rapid agitation and then held for 60 minutes. Charge 8 was added under agitation as the dispersion continued to cool to ambient temperature (about 25° C.). The resulting aqueous dispersion of the cationic polymeric dispersant had a solids content of 16.70%.

The weight average molecular weight (Mw) and z-average molecular weight (Mz) were determined by Gel Permeation Chromatography (GPC). For polymers having a z-average molecular weight of less than 900,000, GPC was performed using a Waters 2695 separation module with a Waters 410 differential refractometer (RI detector), polystyrene standards having molecular weights of from approximately 500 g/mol to 900,000 g/mol, dimethylformamide (DMF) with 0.05 M lithium bromide (LiBr) as the eluent at a flow rate of 0.5 mL/min, and one Asahipak GF-510 HQ column for separation. With respect to polymers having a z-average molecular weight (Mz) of greater than 900,000 g/mol, GPC was performed using a Waters 2695 separation module with a Waters 410 differential refractometer (RI detector), polystyrene standards having molecular weights of from approximately 500 g/mol to 3,000,000 g/mol, dimethylformamide (DMF) with 0.05 M lithium bromide (LiBr) as the eluent at a flow rate of 0.5 mL/min, and one Asahipak GF-7M HQ column for separation. This procedure was followed for all of the molecular weights measurements included in the Examples. It was determined that the cationic polymeric dispersant had a weight average molecular weight of 207,774 g/mol, and a z-average molecular weight of 1,079,872 g/mol.

### Example 8: Synthesis of a Cationic Polymer

TABLE 5

| Charge # | Material | Amount (g) |
|---|---|---|
| 1 | Product of Example 7 (cationic salt | 726.1 |
| | group-containing polymeric dispersant) | |
| | Deionized Water | 680.1 |
| 2 | Ethyl Acrylate | 87.6 |
| | Styrene | 93.8 |
| | 2-Hydroxypropyl Methacrylate | 20.9 |
| | Trimethylolpropane triacrylate | 6.2 |
| 3 | Deionized Water | 26.7 |
| | Hydrogen Peroxide (35% in Deionized | 3.2 |
| | Water) | |
| 4 | Iso-Ascorbic Acid | 0.6 |
| | Ferrous Ammonium Sulfate | 0.006 |
| | Deionized Water | 43.6 |
| 5 | Deionized Water | 5.0 |
| | Hydrogen Peroxide (35% in Deionized | 0.09 |
| | Water) | |
| 6 | Iso-Ascorbic Acid | 0.09 |
| | Deionized Water | 5.0 |

An aqueous dispersion of Example 8 was formed from the ingredients included in the table. Example 8 includes the cationic polymeric dispersant and an ethylenically unsaturated monomer composition having 10% by weight of a hydroxyl-functional (meth)acrylate (2-hydroxypropyl methacrylate), based on the weight of the ethylenically unsaturated monomer composition. Example 8 was prepared as follows: Charge 1 was added to a 4-necked flask fitted with a thermocouple, nitrogen sparge, and a mechanical stirrer. Under a nitrogen blanket and rigorous stirring, the flask was heated to 25° C. At 25° C., the solution was sparged under nitrogen for an additional 30 minutes. Charge 2 was then added to the reaction vessel over 10 minutes. Charge 3 was then added to the reaction vessel over 2-3 minutes. The components of charge 4 were mixed together and added to the reactor through an addition funnel over 30 minutes. The reaction was allowed to exotherm during the addition of charge 4. After the addition was complete, the reactor was heated to 50° C. and held at that temperature for 30 minutes. Charges 5 and 6 were added dropwise and held for 30 minutes at 50° C. The reactor was then cooled to ambient temperature.

The solids content of the resulting aqueous dispersion of Example 8 was determined using the method described for Examples 2-5. The measured solids content was 19.23%. The weight average molecular weight of Example 8 was 655,838 g/mol and the z-average molecular weight of Example 8 was 1,395,842 g/mol, as measured according to the method described in Example 7.

### Example 9: Surfactant Blend

TABLE 6

| Material # | Description | Parts by Weight |
|---|---|---|
| 1 | 2-butoxyethanol | 31.26 |
| 2 | Surfynol 104 | 31.26 |
| 3 | Amine C¹ | 32.46 |
| 4 | 75% Acetic acid in Water | 5.01 |

¹4,5-Dihydro - 1H-Imidazole-1-ethanol available from Ciba Geigy.

Materials 1-4 were blended sequentially.

### Example 10: Preparation of Electrodepositable Coating Compositions A-D

TABLE 7

| | | Composition | | | |
|---|---|---|---|---|---|
| Charge | Material | A | B | C | D |
| 1 | Resin 2 | 971.42 | — | — | — |
| | Resin 3 | — | 981.21 | — | — |
| | Resin 4 | — | — | 990.16 | — |
| | Resin 5 | — | — | — | 1005.36 |
| 2 | Example 6 | 122.47 | 122.47 | 122.47 | 122.47 |
| 3 | Example 9 | 8.934 | 8.934 | 8.934 | 8.934 |
| 4 | Butyl Carbitol Formal¹ | 12.70 | 12.70 | 12.70 | 12.70 |
| 5 | Phenoxy Propanol | 8.2 | 8.2 | 8.2 | 8.2 |
| 6 | Bismuth-Containing Resin² | 429.54 | 429.54 | 429.54 | 429.54 |
| 7 | Example 8 | 97.24 | 97.24 | 97.24 | 97.24 |
| 8 | DI Water | 113.65 | 103.86 | 94.91 | 79.72 |
| 9 | Pigment Paste³ | 385.95 | 385.92 | 385.95 | 385.92 |
| 10 | DI Water | 1649.30 | 1649.30 | 1649.30 | 1649.30 |

¹Available as MAZON 1651 from BASF Corporation.
²A 40% solids cationic epoxy resin dispersion containing 0.84% bismuth on total weight available from PPG Industries.
³Pigment paste E6478 available from PPG consisting of 52% solids at a p:b if 1.22. Contains 1.28% on total weight of catalyst described in US7842762 available from PPG Industries.

Charges 1-8 were added to a plastic container in order and stirred for 15 minutes from Table 6. Charge 9 and 10 were added and stirred for a minimum of 1 hour. The sub-total of charges 1-8 represents the total weight of resin blend. The bath composition had a solids content of 21.5% and a pigment to binder ratio of 0.15/1.0 by weight.

After 25% ultrafiltration (and reconstitution with deionized water), coated panels were prepared from a bath containing the cationic electrodepositable coating composition.

### Evaluation of Coating Compositions A-D

### Oil Spot Contamination Resistance Testing

The above-described electrodepositable paint compositions were then electrodeposited onto cold rolled steel test panels, 4×6×0.031 inches, pretreated with CHEMFOS C700/DI (CHEMFOS C700 is a zinc phosphate immersion pretreatment composition available from PPG Industries, Inc.). These panels are available from ACT Laboratories of Hillside, Mich. The panels were electrocoated in a manner well-known in the art by immersing them into a stirring bath at 30-34° C. and connecting the cathode of a direct current rectifier to the panel and connecting the rectifier's anode to stainless steel tubing used to circulate cooling water for bath temperature control. The voltage was increased from 0 to a set point voltage of 190V over a period of 30 seconds and then held at that voltage for an additional 120 seconds. This combination of time, temperature, and voltage provided a cured dry film thickness of 20 microns for all paints.

After electrodeposition, the panels were removed from the bath, rinsed vigorously with a spray of deionized water, and cured by baking for 25 minutes at 177° C. in an electric oven.

The substrate panels comprising the electrodeposited coating layers were tested for oil spot contamination resistance, which evaluates the ability of an electrodeposited coating to resist crater formation upon cure. The electrodeposited coating layers were tested for oil spot crater resistance by localized contamination of the dried coating layers using three common oils: Ferrocote 6130 (Quaker Chemical Corporation, F), LubeCon Series O Lubricant (Castrol Industrial North America Inc., L) or Molub-Alloy Chain Oil 22 Spray (Castrol Industrial North America Inc., M). The oil was deposited as a droplet (<0.1 μL) onto the dried coating layers using a 40% by weight solution of the LubeCon Series O Lubricant in isopropanol, a 40% by weight solution of the or Molub-Alloy Chain Oil 22 Spray in isopropanol, or a 40% by weight solution of Ferrocote 6130 in isopropanol/butanol (75%/25% by weight) and a micropipette (Scilogex). The oil-spotted substrate panels were then cured as described above (baked for 20 minutes at 177° C. in an electric oven).

Each substrate panel was scanned using Keyence VR3200 3D Macroscope to examine the depth of crater defects in the cured coating layer. The differences between the highest peak and lowest pit points of each of the resulting craters in each coating layer (crater depth, A) were averaged (at least 4 craters per coating layer) to quantify the results of the oil spot test. This test is referred to herein as the CRATER DEPTH TEST METHOD. The results are summarized in Table 8, below.

### Appearance Testing

The paints were coated on to Zinc electrogalanzed (EZG) panels that are 4×6×0.031 inches and pretreated with CHEMFOS C700/DI (CHEMFOS C700 is a zinc phosphate immersion pretreatment composition available from PPG Industries, Inc.). These panels are available from ACT Laboratories of Hillside, Mich. After electrodeposition, the panels were removed from the bath, rinsed vigorously with a spray of deionized water, and cured by baking for 25 minutes at 177° C. in an electric oven. Coated panel texture was evaluated using a Mitutoyo Surftest SJ-402 skidless stylus profilometer equipped with a 4 mN detector and a diamond stylus tip with a 900 cone and a 5 μm tip radius. The scan length, measuring speed, and data sampling interval were 48 mm, 1 mm/s, and 5 μm, respectively. The sampling data was transferred to a personal computer by use of a USB port located on the profilometer, and the raw data was first filtered to a roughness profile according to ISO 4287-1997 3.1.6 using an Lc parameter of 2.5 mm and an Ls parameter of 8 μm before summarizing an Ra metric according to ISO 4287-1997 4.2.1, hereinafter referred to as Ra (2.5 mm). Ra values for compositions A-D are reported in Table 8.

The coated panels were also evaluated for gloss. 200 and 60° gloss was measured using a BYK-Gardner Hazemeter (catalog no. 4601) according to ASTM D523.

### Adhesion Testing

White alkyd adhesion testing evaluates the ability of a second cured coating layer to adhere to the underlying cured electrodeposited coating. White alkyd paint, C354-W404, available from PPG Industries, Inc., was reduced to a viscosity of 100 centipoise as measured at 20 rpm by a Brookfield DV-I Prime viscometer fitted with a cone and plate accessory. The reducing solvent was butyl acetate. E-coated test panels were prepared as described and baked in an electric oven at 155° C. or 175° C. for 25 minutes or 195° C. for 50 minutes. A wet white alkyd coating was applied to the cured e-coat using a #55 (0.055-inch diameter wire) wire-wound coating rod, available from R. D. Specialties. After allowing the white alkyd coating to flash for 10 minutes under ambient conditions, the panels were cured by baking horizontally for 30 minutes at 150° C. in an electric oven. After the panels had cooled to ambient temperature (about 25° C.), they were subjected to a crosshatch test.

The crosshatch test uses a scribing tool with teeth set 2 mm apart which cut the coating system down to metallic substrate. With two such perpendicular cuts, a “crosshatch” results which is then tested with Scotch 898 tape. Failure constitutes loss of adhesion between the alkyd coating and the electrodeposited coating. Crosshatch adhesion results were tested on a scale of 0 to 10, with 0 being the worst and 10 being the best and are reported in the following table. A score of 0 indicates that the cured alkyd paint has been completely removed by the tape from within the scribed area. A score between 0 and 10 indicates that progressively less cured alkyd paint is removed by the tape from within the scribed area, paint being typically removed from the corners where two scribed lines intersect. A score of 10 indicates that there is no evidence of cured alkyd paint being removed by the tape from any of the corners where two scribed lines intersect. As used herein, this test is referred to as the WHITE ALKYD ADHESION TEST.

TABLE 8

| | Appearance | | | | | | | | |
|---|---|---|---|---|---|---|---|---|---|
| | Ra | 20° | 60° | Crater Depth Test | | | White Alkyd Adhesion Test | | |
| Paint | (2.5 mm) | Gloss | Gloss | L | F | M | 155° C. | 175° C. | 195° C. |
| A | 0.19 | 28 | 75 | 14 | 18 | 15 | 9 | 7.5 | 4.5 |
| B | 0.21 | 29 | 77 | 18 | 17 | 15 | 10 | 10 | 8.5 |
| C | 0.23 | 26 | 72 | 16 | 17 | 14 | 10 | 10 | 10 |
| D | 0.24 | 19 | 59 | 7 | 10 | 4 | 10 | 9.5 | 9 |

The results in Table 8 demonstrate incorporating the inventive polymer into the electrodepositable composition improves the performance on the CRATER DEPTH TEST METHOD and the WHITE ALKYD AHESION TEST without significantly increasing the Ra (2.5 mm) values. Further, the gloss values are decreased without impacting the roughness of the coating as well.

It will be appreciated by skilled artisans that numerous modifications and variations are possible in light of the above disclosure without departing from the broad inventive concepts described and exemplified herein. Accordingly, it is therefore to be understood that the foregoing disclosure is merely illustrative of various exemplary aspects of this application and that numerous modifications and variations can be readily made by skilled artisans which are within the spirit and scope of this application and the accompanying claims.

1. An electrodepositable coating composition comprising:
(a) a polyol comprising the residue of ethylene oxide and butylene oxide;
(b) an ionic salt group containing film-forming polymer; and
(c) a curing agent.

2. (canceled)

3. The electrodepositable coating composition of claim 1, wherein the molar ratio of ethylene oxide to butylene oxide is 9:1 to 1:9.

4. (canceled)

5. The electrodepositable coating composition of claim 1, wherein the theoretical molecular weight of the polyol is 1,000 g to 3,000 g.

6. (canceled)

7. The electrodepositable coating composition of claim 1, wherein the polyol has a theoretical hydroxyl equivalent weight of 500 g/OH to 2,000 g/OH.

8. (canceled)

9. The electrodepositable coating composition of claim 1, wherein the polyol has a hydroxyl value of 35 to 115 mg KOH/gram polyol.

10. The electrodepositable coating composition of claim 1, wherein the polyol comprises two hydroxyl functional groups.

11. (canceled)

12. The electrodepositable coating composition of claim 1, wherein the polyol is present in the electrodepositable coating composition in an amount of 0.5% by weight to 15% by weight based on the total weight of the resin solids.

13. The electrodepositable coating composition of claim 1, wherein the electrodepositable coating composition is substantially free of catalytic tin.

14. The electrodepositable coating composition of claim 1, wherein the curing agent comprises a blocked polyisocyanate.

15. The electrodepositable coating composition of claim 14, wherein the blocked polyisocyanate is at least partially blocked with the polyol as a blocking agent.

16. The electrodepositable coating composition of claim 1, wherein the electrodepositable coating composition further comprises a polyetheramine-adduct.

17. The electrodepositable coating composition of claim 1, wherein the ionic salt group containing film-forming polymer comprises a cationic salt group containing film-forming polymer.

18. The electrodepositable coating composition of claim 1, wherein the ionic salt group containing film-forming polymer comprises an anionic salt group containing film-forming polymer.

19. (canceled)

20. The electrodepositable coating composition of claim 1, wherein the ionic salt group-containing film-forming polymer is present in an amount of 39.5% to 90% by weight based on total weight of the resin solids, and the curing agent is present in an amount of 10% to 60% by weight based on total weight of the resin solids.

21-23. (canceled)

24. The electrodepositable coating composition of claim 1, wherein the electrodepositable coating composition comprises a pigment to binder ratio of 0.05:1 to 2.0:1.

25. A method of coating a substrate comprising electrophoretically applying the electrodepositable composition of claim 1 to at least a portion of the substrate and at least partially curing the coating composition to form a coating.

26. A substrate coated with the electrodepositable coating composition of claim 1 in an at least partially cured state.

27. A substrate comprising a coating comprising:
(a) a polyol comprising the residue of ethylene oxide and butylene oxide;
(b) an ionic salt group containing film-forming polymer; and
(c) a curing agent.

28. The substrate of claim 26, wherein the coating on the substrate has an adhesion rating of at least 8.5 as measured by the White Alkyd Adhesion Test.

29. The substrate of claim 26, wherein the substrate comprises a three-dimensional component formed by an additive manufacturing process.

30. (canceled)
